(19) United States
(12) Patent Application Publication
(10) Pub. No.: US 2020/0122816 A1
(43) Pub. Date: Apr. 23, 2020

(54) BULKHEAD JOINT ASSEMBLY

(71) Applicant: THE BOEING COMPANY, Chicago, IL (US)

(72) Inventors: Joel Joseph, Mill Creek, WA (US); Paul Diep, Bothell, WA (US); Bernhard Dopker, Bellevue, WA (US); Mark J. Buckley, Snohomish, WA (US)

(73) Assignee: THE BOEING COMPANY, Chicago, IL (US)

(21) Appl. No.: 16/166,785

(22) Filed: Oct. 22, 2018

(51) Int. Cl. B64C 1/06; B64C 1/10; B64C 1/26

(52) U.S. Cl. CPC B64C 1/069; B64C 1/064; B64C 1/26; B64C 1/10

(57) ABSTRACT

A bulkhead joint assembly that includes a strap section configured to secure to an aft section of a fuselage and forward section of the fuselage and extend past a bulkhead of the fuselage. The bulkhead joint assembly also includes a chord engaging and secured to the strap section, wherein the chord is configured to extend along the bulkhead to transfer a force from the bulkhead in shear between the chord and the strap section.

### FIELD OF THE DISCLOSURE

Embodiments of the present disclosure generally relate to an aircraft fuselage, and, more particularly, to a bulk head of a fuselage.

### BACKGROUND OF THE DISCLOSURE

Fuselages are the main body of an aircraft. Within the fuselage a bulkhead is provided to couple to the horizontal stabilizer of the aircraft and to transfer load from the horizontal stabilizer, through the bulkhead and to structural components of the fuselage.

Great care is taken to ensure that the bulkhead is properly installed and transfers forces though the fuselage components without damaging the fuselage. A fuselage includes numerous sections. With relation to the bulkhead, the sections surrounding the bulkhead are considered an aft section and forward section, with the bulkhead spanning both sections. A bulkhead joint assembly couples and secures these components of the fuselage to facilitate the transfer of force from the bulkhead to structural elements of the aft section and forward section.

A known example of a bulkhead joint assembly includes opposing bulkhead attaching break ring chords of differing sizes that are secured on opposite sides of the bulkhead. In one example, bathtub fittings are aligned and placed against the chords on opposite sides of the bulkhead and secure to a corresponding aft section and forward section of a fuselage to form a tension joint between the bathtub fittings to resist movement of the bulkhead.

However, such a tension-based bulkhead joint assembly is inefficient in transferring forces and requires an intensive installation process. Additionally, such a bulkhead joint assembly of a fuselage includes numerous components that need to be spliced, which also leads to difficulties and complexity during manufacturing. To handle bulkhead forces, numerous components include metal such as aluminum that may corrode, for example. Such metals are also expensive, add manufacturing process such as deburring, and require higher levels of coordinated fit-up processes for final installation, and in general are difficult to work with during installation. Additionally, often to reduce corrosive effects on such metal, corrosive resistant sealants are utilized further increasing costs.

### SUMMARY OF THE DISCLOSURE

A need exists for a bulkhead joint assembly for a fuselage that couples to the interior of the fuselage while efficiently transferring forces on the bulkhead to the other components of the fuselage. Further, a need exists to minimize effects of corrosion on the fuselage and to have a bulkhead joint assembly design that minimizes spliced components, simplifies manufacturing processes, and reduces cost. In addition, a need exists for a simplified bulkhead joint to reduce cost and complexity associated with installation of a bulkhead assembly.

With those needs in mind, certain embodiments of the present disclosure provide a bulkhead joint assembly that includes a strap section configured to secure to an aft section of a fuselage and forward section of the fuselage and extend past a bulkhead of the fuselage. The bulkhead joint assembly also includes a chord engaging and secured to the strap section, wherein the chord is configured to extend along the bulkhead to transfer a force from the bulkhead in shear between the chord and the strap section.

In at least one embodiment, a fuselage is provided including an aft section and a forward section matingly receiving the aft section at a bulkhead joint. A bulkhead extends around an interior of the aft section and an interior of the forward section adjacent the bulkhead joint. A bulkhead joint assembly secures the aft section to the forward section and includes a strap section secured to the aft section and extending to and secured to the forward section. The strap section extends between the bulkhead and the bulkhead joint. The bulkhead joint assembly also includes a chord engaging and secured to the strap section, wherein the chord is configured to extend along the bulkhead to transfer a force from the bulkhead in shear between the chord and the strap section.

In at least one embodiment, a bulkhead joint assembly is provided that includes a strap section configured to secure to an aft section and forward section and extend past a bulkhead. The bulkhead joint assembly also includes an chord engaging and secured to the strap section and configured to extend along the bulkhead to transfer a force from the bulkhead in shear between the chord and the strap section, an aft stringer end fitting secured to the strap section and extending to and configured to be secured to the aft section, and a forward stringer end fitting secured to the strap section and extending to and configured to be secured to the forward section. The bulkhead joint assembly also includes a T-shaped chord section butting against the strap section.

### BRIEF DESCRIPTION OF THE DRAWINGS

FIG. 1 is a partial side plan view of a fuselage according to an embodiment of the present disclosure.

FIG. 2 is a partial exploded perspective view of a fuselage according to an embodiment of the present disclosure.

FIG. 3 is a forward side perspective view of a bulk head joint assembly according to an embodiment of the present disclosure.

FIG. 4 is an aft side perspective view of a bulk head joint assembly according to an embodiment of the present disclosure.

FIG. 5 is a side sectional view of a bulk head joint assembly according to an embodiment of the present disclosure.

FIG. 6 is a partial side section view of a bulkhead joint assembly, according to an embodiment of the present disclosure.

FIG. 7 is a side perspective view of a strap section of a bulk head joint assembly, according to an embodiment of the present disclosure.

FIG. 8 is a side perspective view of a stringer end fitting of a bulk head joint assembly, according to an embodiment of the present disclosure.

FIG. 9 is a side perspective view of a chord of a bulk head joint assembly, according to an embodiment of the present disclosure.

FIG. 10 is a side perspective view of a T-shaped chord of a bulk head joint assembly, according to an embodiment of the present disclosure.

### DETAILED DESCRIPTION OF THE INVENTION

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide a bulk head joint assembly that includes strap sections configured to be tapered and extend under the bulk head and to receive stringer end fittings on both the forward side of the bulk head and the aft side of the bulk head. The bulk head joint assembly also includes a chord member that secures to and extends along the bulk head and also secures to and extends along the strap section. The chord by being generally positioned between the bulk head and strap section receives force transferred from the bulk head and transfers this force to the strap section as a shear force.

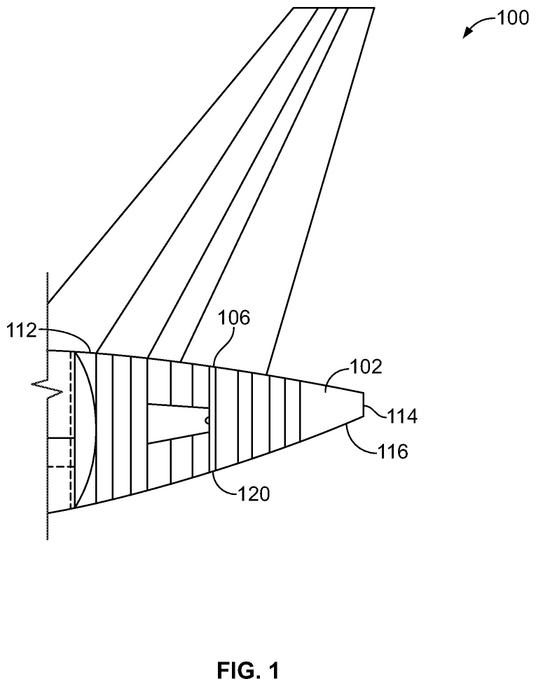

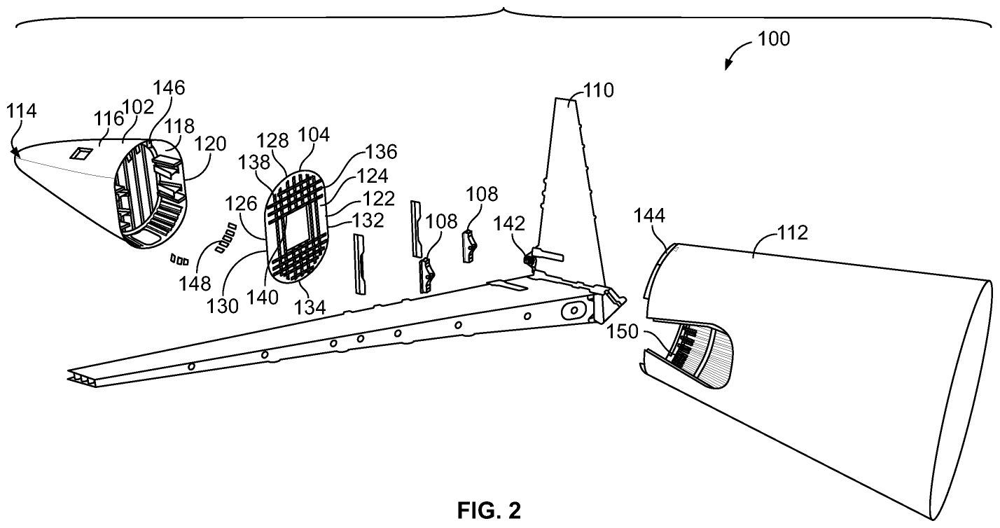

FIG. 1 illustrates a partial side view of a fuselage 100 of an aircraft. FIG. 2 illustrates a partial exploded perspective view of the fuselage 100. As illustrated in FIGS. 1 and 2, the fuselage 100 includes an aft section 102, a bulkhead 104 (FIG. 2), bulkhead joint 106 (FIG. 1), pivot fittings 108 (FIG. 2), a horizontal stabilizer 110, and a forward section 112.

The aft section 102 of the fuselage includes the end point 114 of the aircraft and includes a housing 116, or skin, with an interior, or interior chamber 118 (FIG. 2) configured to receive the bulkhead 104. The housing 116 also includes a periphery 120 that receives the forward section 112 of the fuselage.

The bulkhead 104 includes a web body 122 that includes a forward side 124, an aft side 126, a crown periphery 128, first side periphery 130, second side periphery 132, and keel periphery 134. On the forward side 124 the web body 122 includes a plurality of horizontal support members 136 and vertical support members 138 that surround a bulkhead opening 140 that in one example is generally rectangular in shape. The horizontal support members 136 and vertical support members 138 interconnect with one another to generally form a cross hatched pattern around the bulkhead opening 140. In this manner, the bulkhead 104 is configured to receive and absorb force from the horizontal stabilizer 110 via the pivot fittings 108 secured to the web body 122. While the bulkhead 104 of this exemplary embodiment includes horizontal support members 136 and vertical support members 138 that are generally cross hatched in relation to one another, in other embodiments the support member positioning and shapes are utilized on the web body 122 to provide structural support for the bulkhead 104. Similarly, in other embodiments, only horizontal support members 136 are on the forward side 124 or aft side 126. In another embodiment, only vertical support members 138 are on the forward side 124 or aft side 126.

The pivot fittings 108 secure to the forward side 124 of the web body 122 and pivotably engage the horizontal stabilizer 110. In this manner the horizontal stabilizer 110 is able to pivot in relation to the aft section 102 and forward section 112 of the fuselage 100 for operation of the aircraft.

The horizontal stabilizer 110 includes pivot pins 142 that pivotably connect to the pivot fittings 108. This connection allows pivoting movement between the horizontal stabilizer 110 and aft section 102. The horizontal stabilizer 110 places load on the bulkhead 104 that the bulkhead must absorb and transfer to the rest of the fuselage structure.

The forward section 112 is configured to matingly receive the horizontal stabilizer 110 to allow movement of the horizontal stabilizer 110 relative to the forward section 112. The forward section 112 also has a periphery 144 that is configured to receive the periphery 120 of the aft section 102.

Aft crown stringer end fittings 146 and aft keel stringer end fittings 148 are also provided for coupling the aft section 102 to the bulkhead 104. Similarly, forward keel stringer end fittings 150 are also provided with forward crown stringer end fittings (not shown) to couple the forward section 112 to the bulkhead 104.

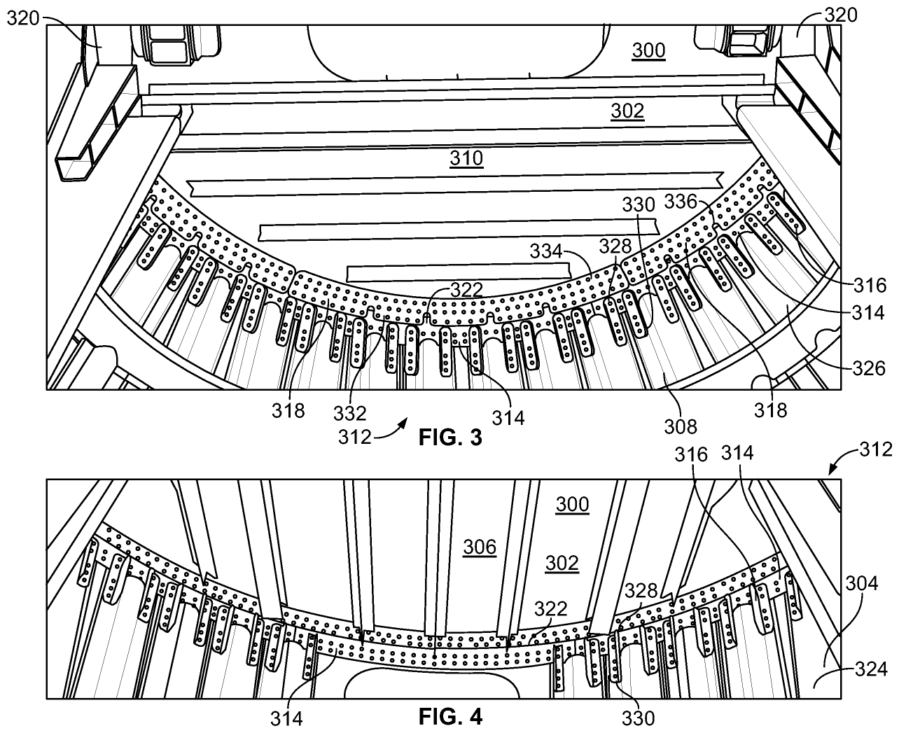

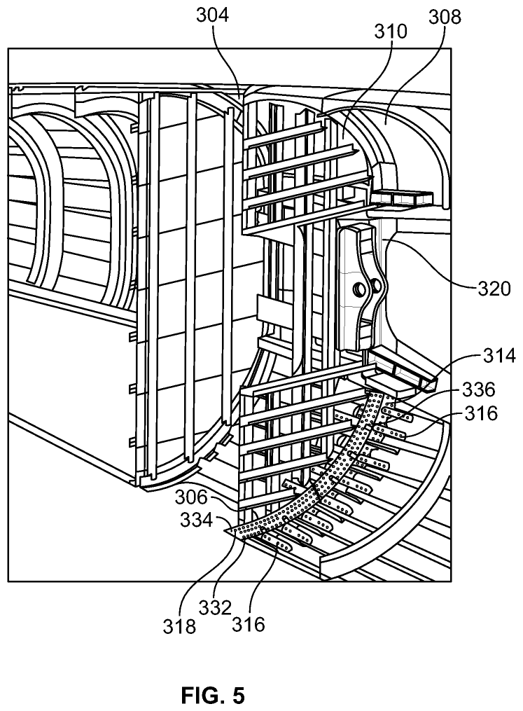

FIG. 3 illustrates a partial view of a bulkhead 300 including a web body 302 disposed within the forward section 308 viewed from within the forward section 308 such that a forward side 310 of the web body 302 is illustrated. FIG. 4 illustrates a partial view of the bulkhead 300 including the web body 302 within an aft section 304 such that an aft side 306 of the web body 302 is illustrated. FIG. 5 illustrates a partial perspective view of the aft section 304 and forward section 308 and the web body 302 of the bulkhead 300 removed. FIGS. 3-5 collectively illustrate a bulkhead joint assembly 312. While FIGS. 3-5 all illustrate a keel or bottom section of the bulkhead 300, the bulkhead joint assembly 312 may similarly be provided on the crown, or top section of the bulkhead 300 in the same manner as illustrated. In one embodiment the bulkhead 300 is the bulkhead 104 of FIGS. 1-2, aft section 304 is aft section 102 of FIGS. 1-2, and forward section 308 is forward section 112 of FIGS. 1-2.

As illustrated in FIG. 5, the bulkhead joint assembly 312 couples and secures the aft section 304 and forward section 308 and is configured to also couple and secure the aft section 304 and the forward section 308 to the bulkhead 300. The bulkhead joint assembly 312 includes strap sections 314, stringer end fittings 316, chord, or chord sections 318, and T-shaped chord sections 320 (FIGS. 3 and 5). The bulkhead joint assembly 312 in general is secured around a bulkhead periphery 322.

The strap sections 314 extend from an aft side 324 of the bulkhead 300 that is secured to the aft section 304 to a forward side 326 of the bulkhead 300 that is secured to the forward section 308. Specifically, each strap section 314 is generally arcuate in shape to matingly engage the both the aft section 304 and forward section 308. Each strap section 314 additionally extends underneath the bulk head 300. In one example the strap sections 314 are secured to the aft section 304 and forward section 308 by fasteners. In other embodiments rivets, bolts, screws, bonds, welds, other fasteners, or the like are utilized. While illustrated in the exemplary embodiment as multiple sections, the strap sections 314 may be of one-piece construction depending on manufacturing requirements. In one example splice straps are provided to secure to the bulkhead 300 or a corresponding chord section 318 to provide additional strength to the bulkhead joint assembly 312. In one embodiment the strap sections 314 are made from a composite fiber reinforced plastic (CFRP). By being made from CFRP, corrosion of the joint assembly 312 is minimized while manufacturing speed is increased because manufacturing steps including drilling, disassembly, and deburring of metal components, such as bathtub fittings, is eliminated.

The stringer end fittings 316 are positioned in spaced relation to one another along the bulkhead periphery 322 of the bulkhead 300 on both an aft side 324 and forward side 326 of the bulkhead 300. The stringer end fittings 316 each extend from a strap end 328 to a fuselage section end 330. At the strap end 328, the stringer end fittings 316 are secured to the corresponding strap section 314, while at the fuselage section end 330 the stringer end fittings 316 are secured to stringers of either the aft section 304 or the forward section 308. The stringer end fittings 316 thus provide a moment for the bulkhead 300. Because the stringer end fittings 316 are not providing a tension force, the stringer end fittings 316 do not have to necessarily align with one another on opposite sides of the bulkhead 300. Instead the stringer end fittings 316 may be offset from one another on opposite sides of the bulkhead. Additionally, fewer stringer end fittings 316 are required because of the enhanced efficiency of load transfer through the bulkhead joint assembly 312. Thus, cost savings, installation time reduction, and manufacturing time is minimized.

In one example the stringer end fittings 316 are secured to the aft section 304, forward section 308, and strap section 314 by fasteners. In other embodiments rivets, bolts, screws, bonds, welds, other fasteners, or the like are utilized. Each stringer end fitting 316 is shaped to matingly engage the corresponding stringer of an aft section 304 or forward section 308. In one example, each aft section 304 and forward section 308 are generally L-shaped to ensure that the surface of the stringer end fitting 316 secured to the corresponding strap section 314 is flat, or engaging continuously along the surface of the strap section 314. Meanwhile, the surface of the stringer end fitting 316 is secured to a corresponding stringer of the aft section 304 or forward section 308 and thus are considered aft stringer end fittings 316 or forward stringer end fittings 316. Additionally, in the embodiment where the stringer end fitting 316 is generally L-shaped, the section of the stringer end fitting 316 extending away from the secured section to provide additional structural support. In alternative embodiments, other sized and shaped stringer end fittings 316 are utilized including T-shaped stringer end fittings 316. In one embodiment the strap sections 314 are made from a composite fiber reinforced plastic (CFRP). By being made from CFRP, corrosion of the joint assembly 312 is minimized while manufacturing speed is increased because manufacturing steps including drilling, disassembly, and deburring of metal components, such as bathtub fittings, is eliminated.

The chords 318 in one exemplary embodiment are generally L-shaped with each chord including a horizontal section 332 and a vertical section 334 extending at an angle from the horizontal section 332. The angle may be obtuse, acute, or at a right angle. Alternatively, the chord 318 may be generally T-shaped. While illustrated as numerous chords 318, in another embodiment a one-piece chord 318 is provided. The horizontal section 332 engages and is secured to a strap section 314 within the forward section 308. The vertical section 334 meanwhile engages and is secured to the web body 302 of the bulkhead 300. In one example the chords 318 are secured to the other components by fasteners. In other embodiments rivets, bolts, screws, bonding, welds, or the like are utilized. In one example the chord 318 is secured to the strap section 314 and bulkhead 300 with fasteners on a single side of the bulkhead 300 to provide load transfer through the chord 318 on a single side of the bulkhead 300. In another example each chord 318 includes at least one mousehole opening 336 therein to facilitate visual inspection of a corresponding strap section 314. Specifically, each mousehole opening 336 is generally arcuate and extends from partially within the vertical section 334 to partially within and terminates in the horizontal section 332. Additionally, the mousehole opening 336 facilitates part production and assists installation by making the chords 318 more compliant. In one embodiment the chords 318 are made from a composite fiber reinforced plastic (CFRP). By being made from CFRP, corrosion of the joint assembly 312 is minimized while manufacturing speed is increased because manufacturing steps including drilling, disassembly, and deburring of metal components, such as bathtub fittings, is eliminated.

Thus, provided is a bulkhead joint assembly 312 that causes load from the bulkhead 300 to transfer to the chord 318 and through the corresponding strap section 314 to provide an efficient transfer of load. The chords 318 only need to be placed on one side (in this example the forward side 326) of the bulkhead 300 thus reducing the number of chords required. Additionally, because of the efficiency of the transfer of the loads, components of the bulkhead joint assembly 312 including the strap sections 314, stringer end fittings 316, chord sections 318, and T-shaped chord sections 320 can be made from a material that minimizes corrosion such as titanium or a composite such as CFRP instead of a more corrosive metal material such as aluminum. Consequently, cost is reduced, manufacturing processes are simplified, corrosion is minimized, and components are more pliable, facilitating installation. Additionally, splice parts are reduced, again simplifying the manufacturing process. Finally, the simplified design facilitates replacement and repair to the bulkhead 300 and other fuselage components because layers of components no longer need to be disassembled to access such components.

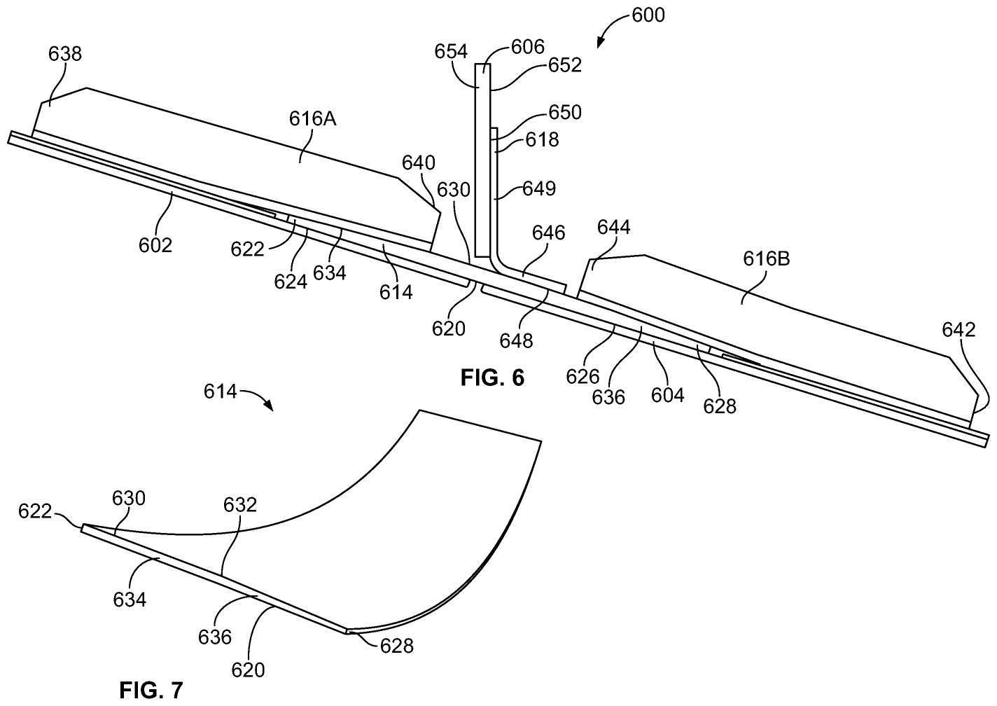

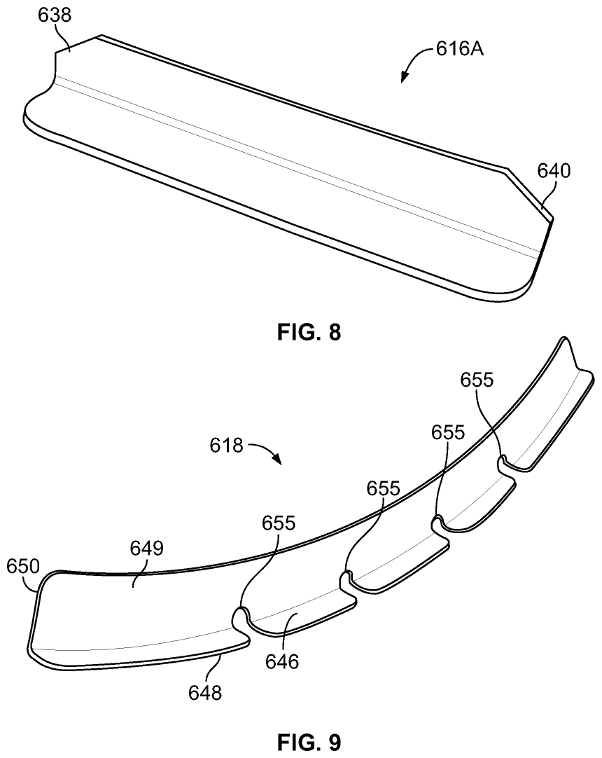

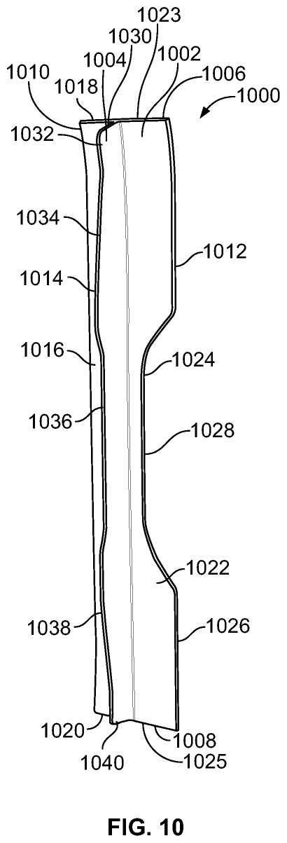

FIG. 6 illustrates a partial side section view of a bulkhead joint assembly 600 that couples an aft section 602, a forward section 604, and a bulkhead 606. In one example, the bulkhead joint assembly 600 is the bulkhead joint assembly 312 of FIGS. 3-5. The bulkhead joint assembly 600 includes a strap section 614, a first stringer end fitting 616A, a second stringer end fitting 616B, a chord section 618, and a T-shaped chord (not shown in FIG. 6). FIGS. 7-10 each illustrate an individual component of the bulkhead joint assembly 600 including the strap section 614 (FIG. 7), the first stringer end fitting 616A (FIG. 8), the chord section 618 (FIG. 9), and a T-shaped chord section 1000 (FIG. 10).

The strap section 614 is configured to mate with the aft section 602 and forward section 604. Specifically, the strap section 614 includes a bottom surface 620 that extends from a first end 622 along an interior, or interior surface 624 of the aft section 602, along an interior, or interior surface 626, or skin, of the forward section 604, and to a second end 628. A gap is formed between the first end 622 of each strap section 614 and adjacent stringers for tolerance during installation and as a drain path for liquid present in this area of the aircraft. Similarly, a gap is formed between the second end 628 and adjacent stringers again for tolerance during installation and as a drain path for liquid present in this area of the aircraft.

The strap section 614 also includes a top surface 630 that in one example tapers toward both the first end 622 and second end 628 (FIG. 6). Alternatively, the top surface 630 in another exemplary embodiment extends parallel to the bottom surface 620 at the first end 622 until tapering toward the bottom surface at a tapering point 632 to form a constant gage section 634 and a tapered section 636 (FIG. 7). In one example of the exemplary embodiment of FIG. 7, the constant gage section 634 is approximately thirty-two (32) piles in thickness and the tapered section 636 extends from a thickness of thirty-two (32) piles at the tapering point 632 to sixteen (16) piles at the second end 628. Because of the constant gage section 634 and tapered section 636, the need for additional shims is greatly reduced and minimized. In this manner, a shimless strap section 614 is provided. The bottom surface 620 additionally extends arcuately (into the page of FIG. 6) as illustrated in FIG. 7. Thus, the bottom surface 620 matingly engages the arcuate interior surface 624, or skin, of the aft section 602 and the interior surface 626, or skin, of the forward section 604.

The first stringer end fitting 616A (FIG. 8) engages and is secured to the aft section 602 at a first end 638 and matingly engages the strap section 614 at a second end 640. Similarly, the second stringer end fitting 616B engages and is secured to the forward section 604 at a first end 642 and matingly engages the strap section 614 at a second end 644. In this manner, the forces of the bulkhead joint assembly 600, including axial forces are provided an efficient load path for forward and aft load transfer between the first stringer end fitting 616A and strap section 614 and between the second stringer end fitting 616B and the strap section 614.

The chord 618 in an exemplary embodiment is generally L-shaped and includes a horizontal section 646 that has a bottom surface 648 that engages and extends along the top surface 630 of the strap section 614. Alternatively, the chord 618 may be generally T-shaped. The horizontal section 646 extends into a vertical section 649 that has a side surface 650 that engages and extends along a forward surface 652 of a web body 654 of the bulkhead 606. In one example the chord 618 is secured to the strap section 614 and bulkhead 606 with fasteners on a single side of the bulkhead 606 to provide load transfer through the chord 618 on a single side of the bulkhead 606. Disposed within the horizontal section 646 and vertical section 649 are mousehole openings 655. The mousehole openings 655 facilitate visual inspection of a corresponding strap section 614. Additionally, the mousehole openings 655 facilitate part production and assists installation by making the chords 618 more compliant.

As illustrated, the chord 618 of this embodiment is not at a right angle and instead has an obtuse angle. Specifically, because the bottom surface 648 of the horizontal section 646 engages and extends along the top surface 630 of the strap section 614, and because the side surface 650 of the vertical section 649 engages and extends along the forward surface 652 of the web body 654, the chord 618 translates load from the bulkhead 606 into a shear force between the chord 618 and strap section 614. Because the loads presented in the joint assembly 600 are efficiently transferred, the joint assembly 600 can be made of a CFRP, improving manufacturing efficiency and cost. In addition, this also reduces the amount of splice joints required, and reduces part number count. The joint assembly 600 also facilitates installation and replacement. Additionally, if supplemental support is desired, splice straps are easily added.

FIG. 10 illustrates an exemplary T-shaped chord section 1000 of a bulkhead joint assembly that in one embodiment is a T-shaped chord section of the T-shaped chord sections 320 of bulkhead joint assembly 312 of FIGS. 3-5. The T-shaped chord section 1000 includes a main body 1002, a flange 1004 extending from the main body 1002, a top edge 1006, an opposite bottom edge 1008, an aft side edge 1010, a forward side edge 1012, and a flange edge 1014. In one example the flange 1004 extends at a right angle from the main body. In another embodiment, the flange 1004 extends to form an acute and obtuse angle with the main body. The T-shaped chord section 1000 within the fuselage spans from the aft section, under the web body of the bulk head to the forward section. The T-shaped chord section 1000 engages and is secured to the web body of the bulkhead, the aft section, and the forward section between a strap section and chord section at the keel of the bulkhead and a strap section and chord section at the crown of the bulkhead. In this manner the T-shaped chord provides a transition from the keel to the crown of a bulkhead joint. Specifically, at the keel end, the bottom edge 1008 butts against, or engages a keel chord and butts against or engages a keel strap section on in the forward section, and butts against, or engages a keel strap section on the aft section. Meanwhile, at the crown end, the top edge 1006 butts against, or engages a crown chord and butts against or engages a crown strap section on in the forward section, and butts against, or engages a crown strap section on the aft section. In one example the T-shaped chord 1000 is secured to the web body of the bulkhead, aft section, and forward section by fasteners. In other embodiments rivets, bolts, screws, bonds, welds, other fasteners, or the like are utilized. In one embodiment the T-shaped chords 1000 are made from titanium. In another embodiment the T-shaped chords 1000 are made in a monolithic process using a CFRP. In yet another embodiment the T-chord is made by combing a CFRP chord and a splice strap. By being made from CFRP, corrosion of joint assembly is minimized while manufacturing speed is increased because deburring of metal connectors, such as bathtub fittings, is eliminated.

The main body 1002 includes an aft section 1016 that extends from the aft side edge 1010 to the flange 1004. The aft section 1016 also extends within and engages an interior wall of an aft section. The aft side edge 1010 extends arcuately from an aft top edge section 1018 to an aft bottom edge section 1020. Specifically, the aft side edge 1010 tapers inwardly from the aft top edge section 1018 and tapers inwardly from the aft bottom edge section 1020.

The main body 1002 also includes a forward section 1022 that extends from the forward side edge 1012 to the flange 1004. The forward section 1022 also extends within and engages an interior wall of a forward section. The forward side edge 1012 extends from a forward top edge section 1023 to an interior arcuate section 1024 that tapers inwardly and back outwardly to a forward bottom edge section 1025. Specifically, the forward section 1022 thus has an outer width 1026 and an inner width 1028 where the inner width 1028 is less than the outer width 1026. The arcuate section 1024 facilitates part production and assists installation by making the T-shaped chord 1000 more compliant.

The flange 1004 includes a flange top surface section 1030 that tapers downwardly to matingly butt against a crown strap section. While in this and other exemplary embodiments illustrated the flange top surface section 1030 matingly butts against the crown strap section, in other embodiments a chord forms a lap splice with the T-shaped chord section 1000, thus overlapping the T-shaped chord section 1000 instead of butting against the crown strap section. The flange top surface section 1030 extends outwardly into a first flange arcuate section 1032 and then inwardly to a flange interior arcuate section 1034. The flange edge 1014 at the flange interior arcuate section 1036 extends outwardly to a second flange arcuate section 1038. The flange interior arcuate section 1036 facilitates part production and assists installation by making the T-shaped chord more compliant. The second flange arcuate section 1038 then tapers to a flange bottom surface section 1040 that tapers downwardly to matingly but against a keel strap section.

Thus, in one exemplary embodiment the T-shaped chord section 1000 extends between and butts against a keel strap section and a keel chord and a crown strap section and a crown chord. Alternatively, a lap spice joint, or joints are provided between the T-shaped chord section 1000 and the keel strap section and crown strap section such that the T-shaped chord section 1000 overlaps either or both of the keel strap section and/or crown strap section as desired. Therefore, the T-shaped chord is provided to efficiently distribute forces at the bulkhead joint. Additionally, the T-shaped chord section is formed to facilitate installation and accommodate corresponding pivot fittings secured to the web body of the bulk head.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A bulkhead joint assembly comprising:
a strap section configured to secure to an aft section of a fuselage and a forward section of the fuselage and extend past a bulkhead of the fuselage; and
a chord engaging and secured to the strap section, wherein the chord is configured to extend along the bulkhead to transfer a load from the bulkhead in shear between the chord and the strap section.

2. The bulkhead joint assembly of claim 1, further comprising:
an aft stringer end fitting secured to the strap section and extending to and configured to be secured to the aft section;
a forward stringer end fitting secured to the strap section and extending to and configured to be secured to the forward section.

3. The bulkhead joint assembly of claim 2, wherein the strap section, the chord, the aft stringer end fitting, and the forward stringer end fitting are made of composite fiber reinforced plastic.

4. The bulkhead joint assembly of claim 1, wherein the strap section includes a constant gage section and a tapered section.

5. The bulkhead joint assembly of claim 1, wherein the chord includes a mousehole opening that extends arcuately in a vertical section of the chord.

6. The bulkhead joint assembly of claim 1, wherein the chord includes a horizontal section that engages and extends along the strap section and a vertical section that is configured to engage and extend along the bulkhead.

7. The bulkhead joint assembly of claim 6 wherein an obtuse angle is formed between the horizontal section of the chord and the vertical section of the chord.

8. The bulkhead joint assembly of claim 1, further comprising:
a T-shaped chord section butting against the strap section.

9. The bulkhead joint assembly of claim 1, further comprising:
a T-shaped chord section overlapping with the strap section.

10. The bulkhead joint assembly of claim 8, wherein the T-shaped chord section includes a main body and a flange extending from the main body.

11. The bulkhead joint assembly of claim 10, wherein the flange of the T-shaped chord section includes a flange interior arcuate section.

12. A fuselage comprising:
an aft section;
a forward section matingly receiving the aft section at a bulkhead joint;
a bulkhead extending around an interior of the aft section and an interior of the forward section adjacent the bulkhead joint; and
a bulkhead joint assembly securing the aft section to the forward section comprising:
a strap section secured to the aft section and extending to and secured to the forward section; the strap section extending between the bulkhead and the bulkhead joint; and
a chord including a horizontal section that engages and extends along the strap section and a vertical section that engages and extends along the bulkhead to provide a shear force between the bulkhead and strap section.

13. The fuselage of claim 12, wherein the bulkhead joint assembly further comprises:
an aft stringer end fitting secured to the strap section and extending to and secured to the aft section;
a forward stringer end fitting secured to the strap section and extending to and secured to the forward section.

14. The fuselage of claim 13, wherein the strap section, the chord, the aft stringer end fitting, and the forward stringer end fitting are made of composite fiber reinforced plastic.

15. The fuselage of claim 12, wherein the bulkhead joint assembly further comprises:
a T-shaped chord section butting against the strap section.

16. The fuselage of claim 15, further comprising:
a pivot fitting that pivotably receives a horizontal stabilizer secured to the bulkhead adjacent the T-shaped chord.

17. The fuselage of claim 12, wherein the chord includes a mousehole opening.

18. The fuselage of claim 12, wherein the chord is secured to the strap section and bulkhead with fasteners on a single side of the bulkhead.

19. A bulkhead joint assembly comprising:
a strap section configured to secure to an aft section of a fuselage and forward section of the fuselage and extend past a bulkhead of the fuselage;
a chord engaging and secured to the strap section, wherein the chord is configured to extend along the bulkhead to transfer a load from the bulkhead in shear between the chord and the strap section;
an aft stringer end fitting secured to the strap section and extending to and configured to be secured to the aft section;
a forward stringer end fitting secured to the strap section and extending to and configured to be secured to the forward section;
a T-shaped chord section butting against the strap section.

20. The bulkhead joint assembly of claim 19, wherein the strap section is one of a plurality of strap sections of the bulkhead joint assembly.
